(19) United States
(12) Patent Application Publication
(10) Pub. No.: US 2011/0034220 A1
(43) Pub. Date: Feb. 10, 2011

(54) HANDSET JACKET STRUCTURE

(76) Inventor: Chang-Chun Lee, Taipei (TW)

Correspondence Address: Yen Jung Sung, 30-47 37 St., Astoria, NY, 11103, US

(21) Appl. No.: 12/537,254

(22) Filed: Aug. 7, 2009

(51) Int. Cl. H04M 1/00

(52) U.S. Cl. 455/575.8

(57) ABSTRACT

A handset jacket structure mainly comprises: a upper protecting frame, being a [symbol] -shaped body, the upper end thereof being opened with a window, one side thereof being indented downward with a proper size of groove, and a proper position of another side thereof being opened with at least one slot corresponding to a connecting hole of the handset; and a lower shielding sheet, configured below the upper protecting frame to form an accepting space between them, being resilient, and having breaches respectively corresponding to the groove and the slot of the upper protecting frame. Whereby, the elasticity of the lower shielding sheet and the groove together with the breaches are operated in coordination with one another to allow a handset to be inserted in the accepting space so as to achieve the protection of the handset.

### FIELD OF THE INVENTION

The present invention relates to a handset jacket, and more particularly to a jacket structure with scrape prevention, collision prevention and easy installment functions; the manufacturing thereof is simple, and the outlook thereof is diversified, providing consumers with variable choices.

### BACKGROUND

Accompanying the progress of electronic technology, communication handsets and multimedia has become the upstarts of information transmission; the volume of a related product is smaller such that it is convenient for carrying. In addition, the voice or picture quality thereof is increased continuously still more such that it can satisfy people's high quality requirement to image and sound.

But, the types of the current common handsets are many, among them the outlook of the iPhone-typed handset is most bright and dazzling and the function thereof is strongest. Related multimedia audio video player include CD Walkman, MP4 player, MP3 player, iPod and the like. The data storage capacity of these handsets are allowed to be increased substantially but the volumes thereof must be reduced to a size equal to human's palm under the progress of technology, ensuring that they can be grasped by a hand, placed around a human's waist, in a bag or car conveniently.

Furthermore, to protect these precise handsets from being dropped to the ground carelessly or scraped by an outside article while being carried, a general user might cover the housing of the handset with a jacket, and the current market available popular handset jackets are almost made from silicon or crystal.

However, the silicon jacket can achieve effects of preventing it from being scraped and absorbing light shock, but it is not hard enough: if an overlarge collision is yielded between it and an outside article accidentally, the handset accepted therein is easy to be damaged due to the collision. In addition, the silicon jacket is yellowing due to oxidization after being used for a period of time. Further, the crystal jacket is a hard shell made from acrylic or plastic; it can prevent the handset effectively from being scraped, falling to damage and invaded by moisture, but a crack always appears on the crystal jacket after it falls down or is collided, causing it not to be eye appealing, and a safety protection thereto is weakened relatively, such that it must be replaced with a new one. In addition, the crystal jacket is not easy to be detached from a handset due to the nature of its design; the handset is sprung out easily due to an improper acting force while the crystal jacket is detached from it.

In addition, the silicon jacket and crystal jacket mentioned above can be manufactured by means of molding so that it is very convenient to produce jackets matching the outlooks of various handsets on large scale. But, on the contrary, it is very difficult to manufacture jackets respectively matching the outlooks of various handsets in practice with the current cloth processing technology if better quality of cloth or leather wants to be used for manufacturing jacket because a special leading angle with an arc raised part at each of the four sides of a jacket must be done by means of three dimensional machine sewing. In addition, the outlook, size and quality of a produced jacket are all very difficult to be controlled.

### SUMMARY OF THE INVENTION

To improve the deficits of a conventional handset jacket mentioned above, the present invention proposes a handset jacket, including: a upper protecting frame, being a [symbol] -shaped body, the upper end thereof being opened with a window, one side thereof is being disposed with a proper size of groove indented downward and another side thereof being opened with at least one slot at a proper position thereof corresponding to connecting holes of a handset; and a lower shielding sheet, configured on a lower end of the upper protecting frame to form an accepting space between the upper protecting frame and the lower shielding sheet, being resilient and constituted by at least one soft outer layer and at least one soft inner protecting layer having the same shapes, the soft outer layer being attached to one face of the soft inner protecting layer to form one integral body and having breaches respectively corresponding to the groove and the slot of the upper protecting frame, ensuring that the handset can be put in the accepting space through the resilience of the lower shielding sheet and operating in coordination with the groove and the slot, thereby protecting the handset from being collided and scraped easily, and reducing a collision force to allow the jacket to attain a buffering protection effect through the protection of the jacket while the handset drops.

### BRIEF DESCRIPTION OF THE DRAWINGS

The present invention can be more fully understood by reference to the following description and accompanying drawings, in which:

FIG. 1 is a perspective view of the present invention;

FIG. 2 is a three dimensional partly cross sectional view of the present invention;

FIG. 3 is an exploded view of the present invention;

FIG. 4 is a schematic view of forming a upper protecting frame according to the present invention;

FIG. 5 is a schematic view of a lower shielding sheet of the present invention;

FIG. 6 is a perspective view of a preferred embodiment of the present invention in which a skidproof pad is attached;

FIG. 7 is a perspective view of a preferred embodiment of the present invention, on the outlook of which a printing pattern is configured;

FIG. 8 is a schematic view of an application of the present invention; and

FIG. 9 is a perspective view of a preferred embodiment of the present invention on witch a decorative border is configured.

### DETAILED DESCRIPTION OF THE PREFERRED EMBODIMENTS

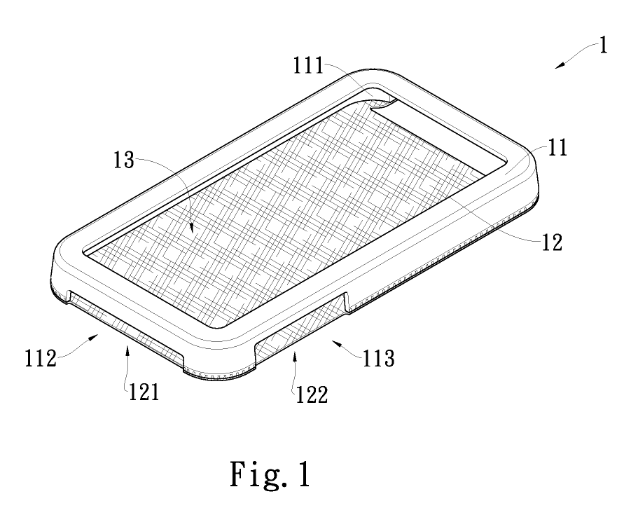

Please refer to FIG. 1, A handset 1 of the present invention includes a upper protecting frame 11 and a lower shielding sheet 12.

Please refer to FIGS. 1 to 4. The upper protecting frame 11 is constituted by at least one soft outer layer 11a, a middle hard plastic plate 11b and a soft inner protecting layer 11c, where the soft outer layer 11a may be a general cloth or leather, various exquisite printing patterns may be added thereon, allowing the product to be more diversified; and the soft inner protecting layer 11c may be a foaming buffering pad or elastic cloth for absorbing collision forces.

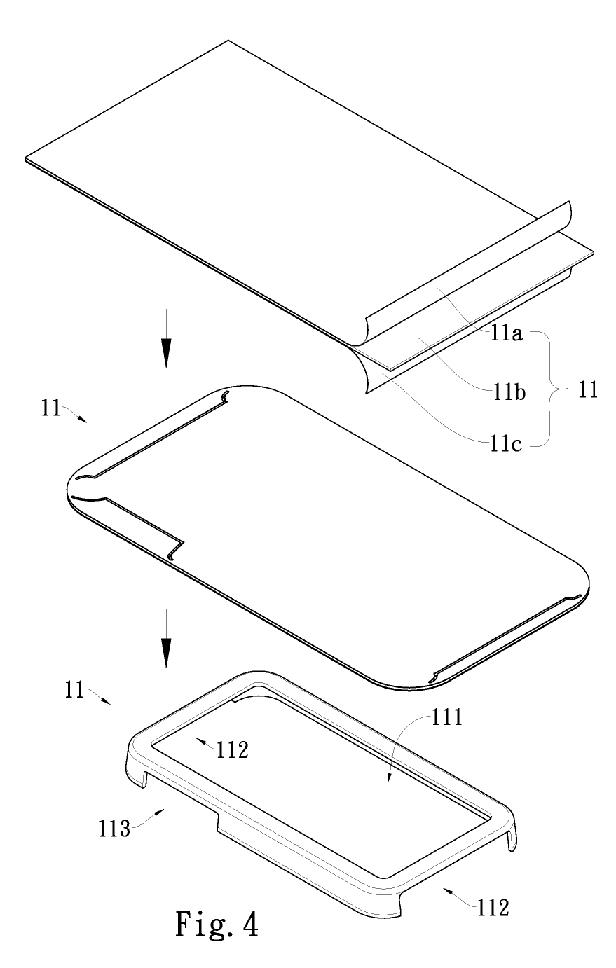

Because the soft outer layer 11a and the soft inner protecting layer 11c are respectively attached to the two opposite faces of the middle hard plastic plate 11b as FIG. 4 shows, ensuring that the soft outer layer 11a and the soft inner protecting layer 11c can be made into every kind of shape by means of mold pressing successfully no matter what material (cloth or leather) they are, allowing the manufacturing thereof to be easier in practice and the outlook, size and quality of a produced jacket 1 to be controlled precisely.

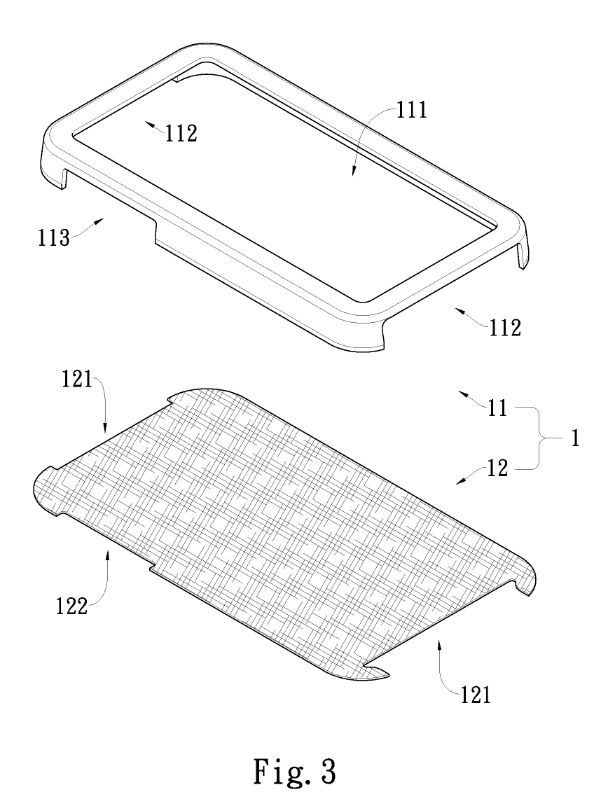

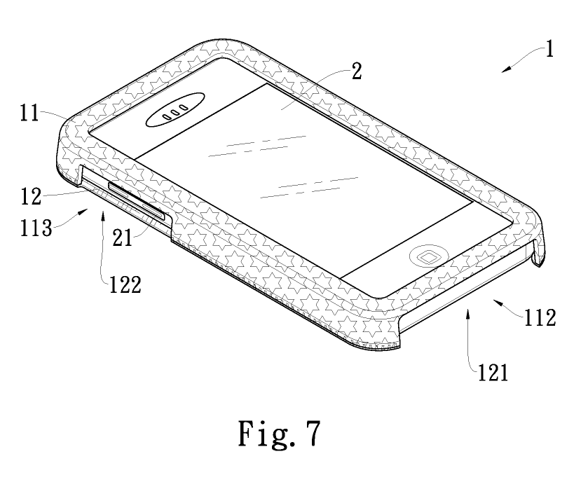

For example, the upper protecting frame 11 can be made into a [symbol] -shaped body by means of mold pressing through the middle hard plastic plate 11b, allowing the soft outer layer 11a and the soft inner protecting layer 11c above and below it to be molded into the [symbol] -shaped bodies too. A window 111 may be opened on the upper end of the [symbol] -typed upper protecting frame 11. A proper size of groove 112 may be indented downward on one side thereof and at least one slot 113 is opened on a proper position at another side thereof depending on the requirement of a product during the manufacturing as FIG. 3 shows, thereby allowing a battery charger, earphone or the like to be inserted in a connecting hole 21 of the handset (please refer to FIG. 7). Therefore, the upper protecting frame 11 can rather be shaped by means of mold pressing directly depending on the customization of the outlook of the handset 2, ensuring that the upper protecting frame 11 and the handset 2 can be combined with each other completely tightly. The example mentioned above takes iPhone as an example to describe, but it is not limited to this according to the present invention.

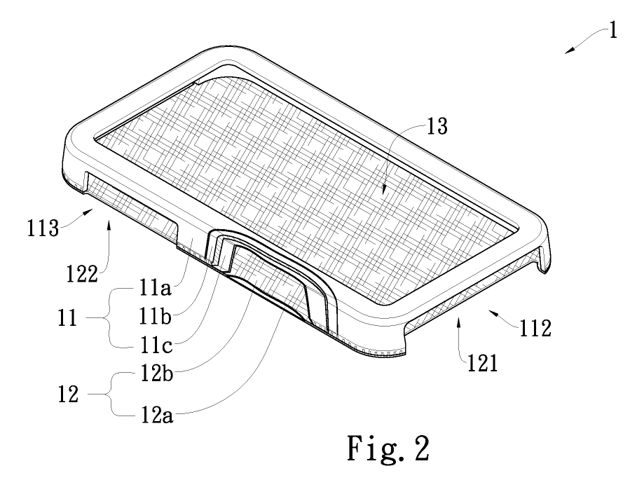

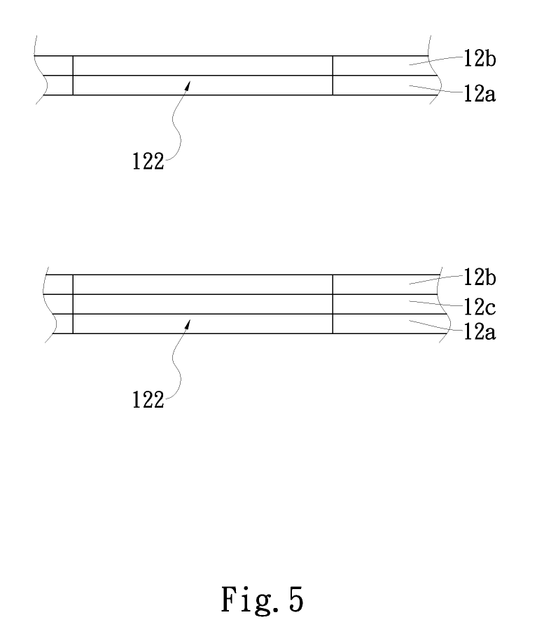

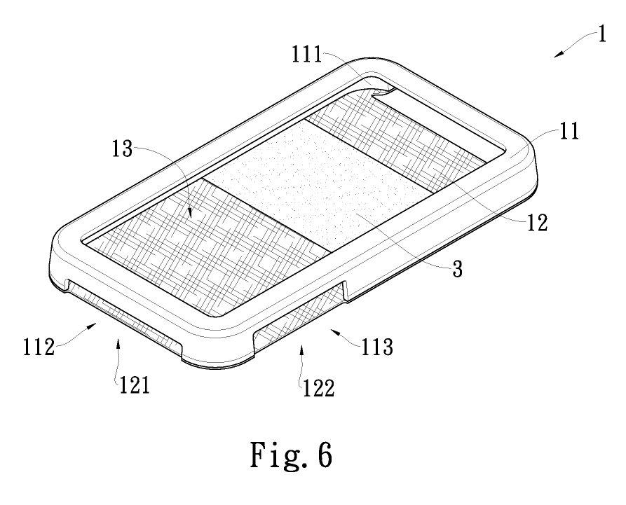

The lower shielding sheet 12 is resilient and configured below the upper protecting frame 11, as FIGS. 1 to 5 show and breaches 121 and 122 respectively corresponding to the groove 112 and the slot 112 of the upper protecting frame are opened thereon. The upper protecting frame 11 is coupled to the lower shielding sheet 12 by means of skin tight seaming, and an accepting space 13 is formed between them as FIGS. 1 and 2 show. An automatic lubrication system disc feed is used to seam border lines between the upper protecting frame 11 and the lower shielding sheet 12, ensuring that the both can be coupled to each other tightly so as to perfect the outlook of the jacket 1. Furthermore, the lower shielding sheet 12 is formed by attaching the same shape of at least one soft outer layer 12a and at least one soft lower protecting layer 12b to each other as FIG. 3 shows, where the soft outer layer 12a may be a general cloth or leather and the soft inner protecting layer 12b may be a foaming buffering pad or elastic cloth. In addition, an inner lining 12c may be disposed between the soft outer layer 12a and the soft lower protecting layer 12b to enhance the buffer protection of the handset 2 as FIG. 5 shows. The coupling is completed by means of sewing in the example mentioned above, but it is not limited to this; the coupling of the soft upper protecting frame 11 and the lower shielding sheet 12 may also be completed by means of adhesion instead of machine sewing as FIG. 6 show.

Please refer to FIG. 7. Not only the upper protecting frame 11 can be formed by means of mold pressing conveniently depending on the outlook of the handset 2 of the customization during the manufacturing, but also the soft outer layer 11a and 12a of the upper protecting frame 11 and the lower shielding sheet 12 can be impressed with a variety of colors and patterns, allowing the outlook of the jacket 1 to be more stereoscopic and eye appealing and providing a user with more variable choices.

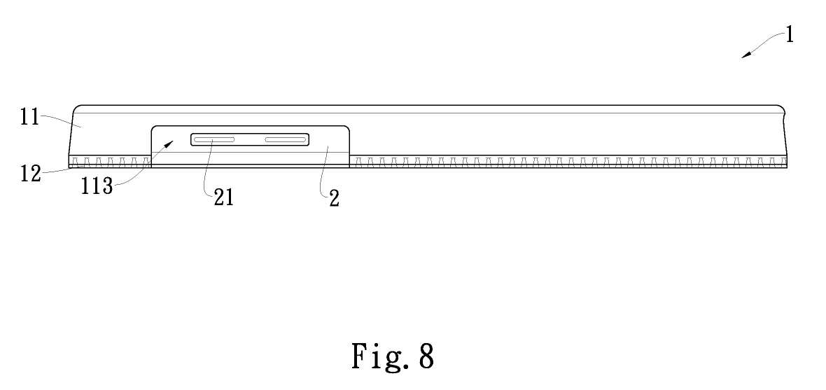

Please refer to FIGS. 7 and 8. FIGS. 7 and 8 show a schematic view of the present invention in practice. The elasticity of the lower shielding sheet 12 of the jacket 1 plus the groove 112 of the upper protecting frame 11 and the breach 121 of the lower shielding sheet 12 allows the jacket 1 to have a variable elastic tension, thereby increasing the convenience of placing or separating the handset 2 into or from the jacket 1. Therefore, the packing and unpacking of the jacket 1 is very easy and the situation that the jacket is not easy to be detached from a handset to cause the handset to drop down to damage in the prior art can be improved.

Furthermore, the handset 2 can be covered by the jacket 1 completely when it is placed in the accepting space 13 smoothly. In addition, the size of the outlook of the upper protecting frame 11 formed by means of precise pressing and the elastic structure design of the lower shielding sheet 12 allows the handset 2 to be engaged with the inside of the upper protecting frame 11 fixedly for protecting the housing of the handset 2 from being scraped, and moreover, the different patterns and colors on the jacket 1 can be used to manifest self styles.

Furthermore, as FIGS. 2 and 5 show, because the upper protecting frame 11 of the composed jacket 1 is rather hard, and the inner portion thereof and the inner portion of the lower shielding sheet 12 are respectively disposed with the buffering and shock absorptive soft inner protecting layers 11c and 12b corresponding to each other, capable of holding the handset 2 tightly as FIG. 7 shows. The jacket 2 can endure and absorb a collision force so as to achieve the protection of the handset 2 while the handset 2 drops to the ground.

In addition, please refer to FIG. 6. To increase the abrasive force of the handset 2 in the jacket, a skidproof pad 3 made from silica gel or rubber may be attached to the upper end of the soft outer layer 12a of the lower shielding sheet 12 or the soft inner protecting layer 11c of the upper protecting frame 11, ensuring that the handset 2 can be retained more steadily after being placed in the jacket 2.

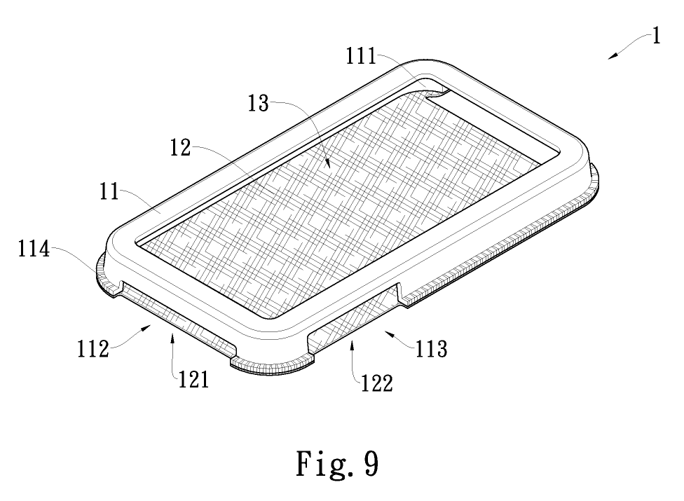

Please refer to FIG. 9. To increase the diversity of the product, the upper protecting frame 11 may also be a body with a decorative border 114 while being manufactured, allowing the jacket with a different modeling to be produced so as to provide a consumer more various different choices after the decorative border 114 at the edge of the upper protecting frame 11 is coupled to the edge of the lower shielding sheet 12.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A handset jacket structure, comprising:
a upper protecting frame, being a [symbol] -shaped body, a upper end thereof being opened with a window, and one side thereof being indented downward with a proper size of groove, a proper position at another side thereof being opened with at least one slot corresponding to a connecting hole of a handset, wherein the upper protecting frame is constituted by at least one soft outer layer, a middle hard plastic plate and a soft inner protecting layer, and the soft outer layer and soft inner protecting layer are respectively attached to two opposite faces of the middle hard plastic plate, allowing the middle hard plastic plate to be sandwiched between the soft outer layer and soft inner protecting layer; and
a lower shielding sheet, being resilient, s breach being opened correspondingly to the groove of the upper protecting frame, the lower shielding sheet being coupled to a lower end of the upper protecting frame to form an accepting space, wherein the lower shielding sheet is constituted by the same shape of at least one soft outer layer and at least one soft inner protecting layer, the soft outer layer is attached to one face of the soft inner protecting layer to integrate therewith.

2. The handset jacket structure according to claim 1, wherein an automatic lubrication system disc feed is used to seam border lines between the upper protecting frame and the lower shielding sheet, ensuring the upper protecting frame and the lower shielding sheet are coupled to each other tightly.

3. The handset jacket structure according to claim 1, wherein various different colors or patterns are printed on the soft outer layers of the upper protecting frame and the lower shielding sheet, allowing a whole outlook of the jacket to be more stereoscopic and eye appealing.

4. The handset jacket structure according to claim 1, wherein the soft outer layer is a general cloth or leather and the soft inner protecting layer is a foaming buffering pad.

5. The handset jacket structure according to claim 1, wherein the soft outer layer of the lower shielding sheet is a general cloth or leather and the soft inner protecting layer is a foaming buffering pad or elastic cloth.

6. The handset jacket structure according to claim 1, wherein an inner lining is sandwiched between the soft outer layer and the soft inner protecting layer.

7. The handset jacket structure according to claim 1, wherein a silicon gel or plastic skidproof pad is attached to a upper end of the soft inner protecting layer of the lower shielding sheet.

8. The handset jacket structure according to claim 1, wherein bottoms of sides of the upper protecting frame are extended outward with a decorative border used for coupling to a rim of the lower shielding sheet.
